(19) United States
(12) Patent Application Publication
(10) Pub. No.: US 2022/0137962 A1
(43) Pub. Date: May 5, 2022

(54) LOGARITHMIC NUMBER SYSTEM

(71) Applicant: XMOS LTD, Bristol (GB)

(72) Inventors: Hendkik Lambertus MULLER, Cumbria (GB); Mark David LIPPETT, Henley on Thames (GB)

(73) Assignee: XMOS LTD, Bristol (GB)

(21) Appl. No.: 17/432,569

(22) PCT Filed: Feb. 14, 2020
(86) PCT No.: PCT/EP2020/053977

§ 371 Date: Aug. 20, 2021

(30) Foreign Application Priority Data
Feb. 21, 2019 (GB) 1902342.3

(51) Int. Cl. G06F 9/30; G06F 7/483

(52) U.S. Cl. CPC G06F 9/3001; G06F 9/3013; G06F 7/4833

(57) ABSTRACT

A processor comprising a register file comprising a bias register for holding a bias and a plurality of operand registers each for holding a respective number which together with the bias represents a respective value in a logarithmic number system; and an execution unit configured to, in response to receiving a logarithmic addition opcode: retrieve first and second numbers from first and second sources respectively; subtract the first number from the second number to determine a difference; and if the determined difference is less than or equal to a predetermined number, retrieve, from a look-up table, a third number mapped to the determined difference, and add the third number to the first number to determine a result; if the determined difference is greater than the predetermined number, determine the result to be the greatest of the first and second numbers; and store the result.

### TECHNICAL FIELD

The present disclosure relates to a processor having an execution unit for computing logarithmic addition instructions. For example, the processor may be used for adding numbers represented in a logarithmic number system.

### BACKGROUND

In computing, numbers are represented by sequences of bits. There are several systems that are used to represent a number based on the sequence of bits. One such system is the floating-point number system, in which a number is represented by two main parts: a significand that contains the number's digits (negative significands represent negative numbers), and an exponent in some fixed base (e.g. base 10). In the case where the base is 10, the exponent determines where a decimal point is placed relative to the beginning of the significand (negative exponents represent numbers that are very small). For example, the number 15000 in base 10 may be represented by a significand equal to 1.5 and an exponent equal to 4.

An alternative to the floating-point number system is the logarithmic number system. In the logarithmic number system, a number X is represented by the logarithm x of its value: X→{s, x=log_{b} X}, where is a sign bit denoting the sign of X (e.g. s=0 if X>0 and s=1 is X<0). That is, X=±b^{x}.

Like floating-point numbers (i.e. numbers represented in the floating-point number system), logarithmic numbers (i.e. numbers represented in the logarithmic number system) can represent a large dynamic range, but unlike floating-point numbers, logarithmic numbers have an even spacing. That is, any two subsequent numbers X and Y, have an identical ratio X/Y. This is particular useful for numbers that are stored in a small number of bits (e.g. 8 bits), where floating-point numbers are spaced unevenly when the exponent changes. However, implementing a logarithmic number system on a computer has its challenges. In particular, it is computationally complex to implement addition and subtraction of logarithmic numbers.

### SUMMARY

A logarithmic number system allows multiplication and division to be performed efficiently using addition and subtraction operations. This makes logarithmic number systems advantageous in applications such as, for example, signal processing, video processing, audio processing, and data transmission. However, the operations of addition and subtraction in previous logarithmic number systems cannot themselves be performed using only addition and subtraction operations. In fact, more complex operations are required. This therefore reduces the efficiency of such a system.

According to one aspect of the present disclosure, there is provided a processor comprising: a register file comprising a plurality of registers, including a bias register for holding a bias and a plurality of operand registers each for holding a respective number which together with the bias represents a respective value in a logarithmic number system; and an execution unit configured to execute machine code instructions, each instruction being an instance of a predefined set of instruction types in an instruction set of the processor, wherein the instruction set includes a logarithmic addition instruction defined by a corresponding opcode, a first source operand field taking a first source operand specifying a first source holding a first number, a second source operand field taking a second source operand specifying a second source holding a second number, and a destination field taking a destination operand specifying one of said operand registers as a destination register; wherein the execution unit is configured to, in response to the logarithmic addition opcode: retrieve the first number from the first source specified in the logarithmic addition instruction; retrieve the second number from the second source specified in the logarithmic addition instruction; subtract the first number from the second number to determine a difference; and if the determined difference is less than or equal to a predetermined threshold number, retrieve, from a logarithmic addition look-up table, a third number mapped to the determined difference, and add the third number to the first number to determine a resulting number; and if the determined difference is greater than the predetermined threshold number, determine the resulting number to be the greatest of the first number and the second number; and store the resulting number in the destination register specified in the logarithmic addition instruction.

The respective number x and the bias B stored in the registers represent a respective value V in the logarithmic number system. In other words, there is a logarithmic mapping from V to {x,B} and an exponential mapping from {x,B} to V. The mapping allows for an efficient implementation of the addition of two values by the processor. The value V may be a variable in a computer program. For instance, values may represent a sound sample. Using the representation, different values may be added to together based on the above rules.

In embodiments, the logarithmic addition look-up table may be stored in the register file.

In embodiments, the instruction set may include a logarithmic subtraction instruction defined by a corresponding opcode, a first source operand field taking a first source operand specifying a first source holding a first number, a second source operand field taking a second source operand specifying a second source holding a second number, and a destination field taking a destination operand specifying one of said operand registers as a destination register; wherein the execution unit is configured to, in response to the logarithmic subtraction opcode: retrieve the first number from the first source specified in the logarithmic subtraction instruction; retrieve the second number from the second source specified in the logarithmic subtraction instruction; subtract the first number from the second number to determine a difference; and if the determined difference is less than or equal to a predetermined threshold number, retrieve, from a logarithmic subtraction look-up table, a third number mapped to the determined difference, and add the third number to the first number to determine a resulting number; and if the determined difference is less than the predetermined threshold number, determine the resulting number to be the greatest of the first number and the second number; and store the resulting number in the destination register specified in the logarithmic subtraction instruction; and if the first number is equal to the second number, determine the resulting number to be zero; and store the resulting number in the destination register specified in the logarithmic subtraction instruction.

In embodiments, the logarithmic subtraction look-up table may be stored in the register file.

In embodiments, the instruction set may include a logarithmic multiplication instruction defined by a corresponding opcode, a first source operand field taking a first source operand specifying a first source holding a first number, a second source operand field taking a second source operand specifying a second source holding a second number, and a destination field taking a destination operand specifying one of said operand registers as a destination register; wherein the execution unit is configured to, in response to the logarithmic multiplication opcode: retrieve the first number from the first source specified in the logarithmic multiplication instruction; retrieve the second number from the second source specified in the logarithmic multiplication instruction; retrieve the bias from the bias register; determine the resulting number by adding the first and second numbers and subtracting the bias; and store the resulting number in the destination register specified in the logarithmic multiplication instruction.

In embodiments, the instruction set may include a logarithmic division instruction defined by a corresponding opcode, a first source operand field taking a first source operand specifying a first source holding a first number, a second source operand field taking a second source operand specifying a second source holding a second number, and a destination field taking a destination operand specifying one of said operand registers as a destination register; wherein the execution unit is configured to, in response to the logarithmic division opcode: retrieve the first number from the first source specified in the logarithmic division instruction; retrieve the second number from the second source specified in the logarithmic division instruction; retrieve the bias from the bias register; determine the resulting number by subtracting the first and second numbers and adding the bias; and store the resulting number in the destination register specified in the logarithmic division instruction.

In embodiments, the destination register specified in the logarithmic addition instruction or the logarithmic multiplication instruction may each have a predetermined bit width, and wherein if the resulting number is larger than a maximum number that can be held by the predetermined bit width, the execution unit is configured to store, in the destination register specified in the logarithmic addition instruction or the logarithmic multiplication instruction, a sequence of bits representing infinity.

In embodiments, the destination register specified in the logarithmic subtraction instruction or the logarithmic division instruction may each have a predetermined bit width, and wherein if the resulting number is less than a minimum number that can be held by the predetermined bit width, the execution unit is configured to store, in the destination register specified in the logarithmic subtraction instruction or the logarithmic division instruction, a sequence of bits representing zero.

In embodiments, the instruction set may include a logarithmic square root instruction defined by a corresponding opcode, a first source operand field taking a first source operand specifying a first source holding a first number, and a destination field taking a destination operand specifying one of said operand registers as a destination register; wherein the execution unit is configured to, in response to the logarithmic square root opcode: retrieve the first number stored in the first source specified in the logarithmic square root instruction; retrieve the bias from the bias register; determine the resulting number by performing a right logical shift on the first number and adding half of the bias to the shifted first number; and store the resulting number in the destination register specified in the logarithmic square root instruction.

In embodiments, the first source and the second source may each be at least one of: a respective one of said operand registers, and a respective data location in memory (e.g. stack memory).

In embodiments, each number held in the set of operand registers may comprise a sign bit representing a positive or negative sign of the number.

In embodiments, the bias may be configurable by a user.

In embodiments, the logarithmic addition look-up table may comprise a plurality of entries each representing a different difference, y−x, between the second number and the first number, and wherein each entry is mapped to a respective third number, wherein each respective third number is equal to the value of 1+b^{y-x} rounded to the nearest value of bⁱ, wherein i is an integer, and wherein b is a base number for representing the value in the logarithmic number system using a number and the bias.

In embodiments, the logarithmic subtraction look-up table may comprise a plurality of entries each representing a different difference, y−x, between the second number and the first number, and wherein each entry is mapped to a respective third number, wherein each respective third number is equal to the value of 1−b^{y-x} rounded to the nearest value of b′, wherein i is an integer, and wherein b is the base number for representing the value in the logarithmic number system using a number and the bias.

In embodiments, b may be equal to 2^{1/K}, and wherein K is configurable by the user.

According to another aspect disclosed herein, there is provided a computer-readable storage medium comprising instructions which, when executed by a computer system comprising a processor according to any of claims 1 to 15, cause the computer system to: convert one or more respective values V stored in data memory into a respective number x, wherein the conversion is based on the logarithmic mapping V=b^{x-B}, where B is the bias and b is a predetermined base number; supply the one or more respective numbers to the processor to be held in a respective one of the plurality of operand registers of the processor; retrieve the resulting number held in the destination register from the processor; and convert the resulting number into a resulting value to be stored in data memory based on the logarithmic mapping.

That is, the computer is programmed to know that a value V is represented by a number x. The number that represents a value depends on the bias value, which may be configurable. The computer supplies and retrieves numbers from the processor for use as variables, e.g. in an audio processing application.

According to another aspect disclosed herein, there is provided a computer system comprising: a processor according to any of the embodiments described herein and a computer-readable storage medium according to any of the embodiments described herein.

According to another aspect disclosed herein, there is provided a method of operating a processor, wherein the processor comprises: a register file comprising a plurality of registers, including a bias register for holding a bias and a plurality of operand registers each for holding a respective number which together with the bias represents a respective value in a logarithmic number system; and an execution unit configured to execute machine code instructions, each instruction being an instance of a predefined set of instruction types in an instruction set of the processor, wherein the instruction set includes a logarithmic addition instruction defined by a corresponding opcode, a first source operand field taking a first source operand specifying a first source holding a first number, a second source operand field taking a second source operand specifying a second source holding a second number, and a destination field taking a destination operand specifying one of said operand registers as a destination register, and wherein the method comprises, in response to the logarithmic addition opcode, the exaction unit performing operations of: retrieving the first number from the first source specified in the logarithmic addition instruction; retrieving the second number from the second source specified in the logarithmic addition instruction; subtracting the first number from the second number to determine a difference; and if the determined difference is less than or equal to a predetermined threshold number, retrieving, from a logarithmic addition look-up table, a third number mapped to the determined difference, and adding the third number to the first number to determine a resulting number; and if the determined difference is greater than the predetermined threshold number, determining the resulting number to be the greatest of the first number and the second number; and storing the resulting number in the destination register specified in the logarithmic addition instruction.

In embodiments, the method may comprise steps in accordance with any of the system features disclosed above or elsewhere herein.

### BRIEF DESCRIPTION OF THE DRAWINGS

To assist understanding of the present disclosure and to illustrate how embodiments may be put into effect, reference is made, by way of example only, to the accompanying drawing in which:

FIG. 1 is a schematic block diagram of a processing system.

### DETAILED DESCRIPTION OF EMBODIMENTS

Logarithmic Number System

According to embodiments of the invention, a value V in a logarithmic number system is represented by:
V=±b^{x-B}, where x is an integer exponent, b is a base, and B is a bias.

The number x is stored in binary as a sequence of n bits (e.g. 7 bits). The bias B allows the overall exponent (x−B) to take both positive and negative values. That is, exponents in the range [−B . . . 2ⁿ−B] may be stored. This therefore enables values X of [b^{-B} . . . b²^{ⁿ}^{-B}] in the positive range to be represented.

A value in the logarithmic number system may therefore be represented in binary (and stored in a register) as a sequence of n+1 bits as follows:

| | | | | | |
|---|---|---|---|---|---|
| s | eₙ₋₁ | eₙ₋₂ | . . . | e₁ | e₀ |

where s is a sign-bit, and eₙ₋₁ . . . e₀ is the binary representation of the number x. For example 1 may signify a negative value and 0 may signify a positive value, and vice versa.

The base b may be set as (e.g. programmed as) b=2^{1/K} for a positive integer K. This simplifies the conversion of values to and from binary numbers.

As an example, if there are a total of n+1=8 bits available for representing a value in the logarithmic number system, with 1 bit being used as the sign bit, n=7 bits being used to represent x in binary, and e in the range [1 . . . 2ⁿ−2] (to allow for binary representations of e.g. zero, infinity and NaN), the following example number systems may be achieved:

| K | b = 2^{1/K} | B | Vₘᵢₙ | Vₘᵢₙ₊₁ | Vₘₐₓ₋₁ | Vₘₐₓ |
|---|---|---|---|---|---|---|
| 4 | 1.189207 | 64 | b⁻⁶³ = 1.81 × 10⁻⁵ | b⁻⁶² = 2.15 × 10⁻⁵ | b⁶¹ = 38968 | b⁶² = 46341 |
| 4 | 1.189207 | 96 | b⁻⁶³ = 7.09 × 10⁻⁸ | b⁻⁶² = 8.43 × 10⁻⁸ | b²⁹ = 152 | b³⁰ = 181 |
| 7 | 1.104090 | 64 | b⁻⁶³ = 1.95 × 10⁻³ | b⁻⁶² = 2.16 × 10⁻³ | b⁶¹ = 464 | b⁶² = 512 |

In this table, the Vₘᵢₙ, Vₘᵢₙ₊₁, Vₘₐₓ and Vₘₐₓ₋₁ columns indicate, approximately, the smallest value that can be represented, the second smallest value that can be represented, the largest value that can be represented, and the second largest value that can be represented, respectively. As shown, for a given number of bits, the range of numbers that can be represented according to this system varies depending on the values of K and B.

Note that the value shown for b is an approximate value; b itself is an irrational number that cannot be accurately represented. However, this is of no concern to the computer hardware that implements arithmetic by rounding all input and intermediate values to the nearest irrational value.

Values of zero and infinity can be represented as follows, where a symmetrical representation allows for both a positive and negative value of zero:

| Value | s | eₙ₋₁ | eₙ₋₂ | . . . | e₁ | e₀ |
|---|---|---|---|---|---|---|
| +0 | 0 | 0 | 0 | . . . | 0 | 0 |
| −0 | 1 | 0 | 0 | . . . | 0 | 0 |
| +Inf | 0 | 1 | 1 | . . . | 1 | 1 |
| −Inf | 1 | 1 | 1 | . . . | 1 | 1 |

If a value for not-a-number is required, a representation of zero can be discarded (e.g. −0), or an additional sequence may be chosen:

| Value | s | eₙ₋₁ | eₙ₋₂ | . . . | e₁ | e₀ |
|---|---|---|---|---|---|---|
| +0 | 0 | 0 | 0 | . . . | 0 | 0 |
| NaN | 1 | 0 | 0 | . . . | 0 | 0 |
| +Inf | 0 | 1 | 1 | . . . | 1 | 1 |
| −Inf | 1 | 1 | 1 | . . . | 1 | 1 |

or

| Value | s | eₙ₋₁ | eₙ₋₂ | . . . | e₁ | e₀ |
|---|---|---|---|---|---|---|
| +0 | 0 | 0 | 0 | . . . | 0 | 0 |
| −0 | 1 | 0 | 0 | . . . | 0 | 0 |
| +NaN | 0 | 1 | 1 | . . . | 1 | 0 |
| −NaN | 1 | 1 | 1 | . . . | 1 | 0 |
| +Inf | 0 | 1 | 1 | . . . | 1 | 1 |
| −Inf | 1 | 1 | 1 | . . . | 1 | 1 |

As a first example, the logarithmic number system may be used to encode sound in terms of a fraction of full scale. In the following example, decimal notation is used to show the value V and 0xYY is used to show the number x in hexadecimal notation. For example, the number 123 in hexadecimal notation is 0x7b.

Let K=8 and B=127. Therefore b=2^{1/K}=1.090507732665. If n+1=8 bits are available, with one bit being the sign bit, and the bit sequence 1 . . . 1 representing infinity, x may take the range of [0 . . . 127], and x-B taking the range of [−127 . . . 0]. Therefore the number system can be used to represent values in the range [−1 . . . 1], with the smallest positive value equal to 0.00001663982746 (i.e. b⁻¹²⁷).

A sine wave with a periodicity of 8 samples with a full scale amplitude can be represented as, where special(0) is used to represent the value zero:

| | x − B = log_{b} V | | | |
|---|---|---|---|---|
| Value, V | (integer) | x | Sign bit | 0xYY |
| 0.0000 | special(0) | | 0 | 0x00 |
| 0.7071 | −4 | 123 | 0 | 0x7b |
| 1.0000 | 0 | 127 | 0 | 0x7f |
| 0.7071 | −4 | 123 | 0 | 0x7b |
| 0.0000 | special(0) | | 0 | 0x00 |
| −0.7071 | −4 | 123 | 1 | 0x7b |
| −1.0000 | 0 | 127 | 1 | 0x7f |
| −0.7071 | −4 | 123 | 1 | 0x7b |

In other words, to represent a value of 0.7071 using the parameters of K=8 and B=127, one determines the closest integer value of x−B that results in that value (in this case 0.7071 is approximately equal to b⁻⁴, since log_{b} X=−4.0001106846), adds the bias B, and stores the resulting number x, preceded by the sign bit, in binary. In this example, the number 123 in binary is 1111011.

Addition

As mentioned above, the addition and subtraction of values in previous logarithmic number system is computationally complex. The logarithmic number system devised by the inventor of the present application reduces this complexity by making use of a look-up table.

Assume we have two positive values Vₓ=b^{x-B} and V_{y}=b^{y-B} which are to be summed. Without loss of generality, we can assume that x≥y, and the sum S of these values is:

S=b^{x-B}+b^{y-B}=b^{x-B}(1+b^{y-B-(x-B)})

which can be rewritten as S=b^{x-B(}1+b^{y-x}).

As x≥y, the second term of this equation can be bounded.

For x=y, 1+b^{y-x}=1+b⁰=1+1=2 (upper limit).

For x»y, 1+b^{y-x}=1+b^{-∞}=1+0=1 (lower limit).

Therefore 1<1+b^{y-x}≤2. Since only integer numbers can be stored in binary The result of this sum has to be rounded to one of the values b⁰, b¹, b² . . . b^{K}. Since b=2^{1/K}, b^{K}=(2^{1/K})^{K}=2, which is the highest value that the equation can take. The question is which values of y−x are important, for x»y, b^{y-x} becomes infinitesimally small. The smallest number that is of importance is the value for which \sqrt{b}=1+b^{y-x}. That is, the value for y-x where the equation is so close to 1 that the rounded value will tend to 1 and not to b.

This equation can be solved as follows:

\sqrt{b}=1+b^{y-x}

\sqrt{b}−1=b^{y-x}

log_{b}(\sqrt{b}−1)=y−x

For example, for K=4, this value is for y−x=−13.86. Hence, a look-up table having 14 entries mapped to values of y−x is required:

| | 1 + b^{y-x} | | Number to store |
|---|---|---|---|
| y − x | (rounded) | Sum S | in binary |
| 0 | b⁴ | b^{x-B}b⁴ = 2b^{x-B} | x + 4 |
| −1 | b⁴ | 2b^{x-B} | x + 4 |
| −2 | b³ | b^{x-B}b³ = | x + 3 |
| | | b^{x-B+3} | |
| −3 | b³ | b^{x-B+3} | x + 3 |
| −4 | b² | b^{x-B}b² = | x + 2 |
| | | b^{x-B+2} | |
| −5 | b² | b^{x-B+2} | x + 2 |
| −6 | b² | b^{x-B+2} | x + 2 |
| −7 | b² | b^{x-B+2} | x + 2 |
| −8 | b¹ | b^{x-B}b¹ = | x + 1 |
| | | b^{x-B+1} | |
| −9 | b¹ | b^{x-B+1} | x + 1 |
| −10 | b¹ | b^{x-B+1} | x + 1 |
| −11 | b¹ | b^{x-B+1} | x + 1 |
| −12 | b¹ | b^{x-B+1} | x + 1 |
| −13 | b¹ | b^{x-B+1} | x + 1 |
| ≤−14 | b⁰ | b^{x-B}b⁰ = b^{x-B} | x |

This means that adding two values Vₓ and V_{y} can be performed by subtracting the exponents y−x, picking a number from a small look-up table, and adding that to the exponent of the largest value. There is a special case where the look-up table is not required, as evidenced by the table above. For any x»y, the Sum S=Vₓ and the look-up table is not required.

In the example above, the table requires 14 entries of 4 bits each. For the case where the number x is represented in binary by 7 bits, the addition involves a 7-bit subtraction, a look-up and a 7-bit addition.

For two negative numbers the above logic equally applies, but the answer is negative in that:

Sum=−Vₓ+−V_{y}=−b^{x-B}+−b^{y-B}=−(b^{x-B}+b^{y-B}). Therefore the sign bit of the resulting sum would be set to 1 (to represent a negative number).

Example:

The sine wave above can be represented using a different bias value, say B=96. For n=7, this means that values with a very small magnitude cannot be represented, but values greater than 1 can be represented.

| | x − B = | | | |
|---|---|---|---|---|
| | log^{b} V | | | |
| Value, V | (integer) | x | Sign bit | 0xYY |
| 0.0000 | special(0) | | 0 | 0x00 |
| 0.7071 | −4 | 92 | 0 | 0x5c |
| 1.0000 | 0 | 96 | 0 | 0x60 |
| 0.7071 | −4 | 92 | 0 | 0x5c |
| 0.0000 | special(0) | | 0 | 0x00 |
| −0.7071 | −4 | 92 | 1 | 0x5c |
| −1.0000 | 0 | 96 | 1 | 0x60 |
| −0.7071 | −4 | 92 | 1 | 0x5c |

The sound sample may be run through a convolution, e.g. the first layer of a neural network.

The convolution mask may be 1,1,1,1,−1,−1,−1,−1. 1 and −1 are represented by b⁰, x=96 (0x60) with sign bit 0 and 1 respectively.

To calculate the convolution, we need to add 0x00, 0x5c, 0x60, 0x5c, 0x00, 0x5c, 0x60, 0x5c (these are the results of multiplying the two vectors). Adding them from left to right gives us:

add(0x00, 0x5c)=b⁻⁴, store x=92 (sign bit 0, 0x5c)

add(0x5c, 0x60)=b⁶, store x=102 (sign bit 0, 0x66)

add(0x66, 0x5c)=b¹⁰, store x=106 (sign bit 0, 0x6a)

add(0x6a, 0x00)=¹⁰, store x=106 (sign bit 0, 0x6a)

add(0x6a, 0x5c)=b¹³, store x=109 (sign bit 0, 0x6d)

add(0x6d, 0x60)=b¹⁶, store x=112 (sign bit 0, 0x70)

add(0x70, 0x5c)=b¹⁸, store x=114 (sign bit 0, 0x72)

Here, b¹⁸=4.7568, which is close to the true answer of 4.828. That value could not have been represented had we chosen the bias to be 127, in which case the second addition would have overflowed to +∞.

Subtraction

Subtraction largely follows the same logic as addition. Assume we have two positive values that we subtract, Vₓ=b^{x-B} and V_{y}=b^{y-B}. We need to recognise a special case here: the case where x=y. In this case the answer is zero which, as discussed above, uses a special representation.

Assuming x≠y, without loss of generality, we assume that x≥y (as b^{x-B}−b^{y-B}=−(b^{x-B}−b^{y-B})). The subtraction of these numbers is s=b^{x-B}−b^{y-B}=b^{x-B}*(1−b^{y-B-(x-B)}), which can be rewritten as s=b^{x-B}(−b^{y-x}).

As x>y, the second term of this equation can be bounded.

For x=y1, 1−b^{y-x}=1−b\hat{ }−1 (lower limit).

For x»y, 1−b^{y-x}=1−b\hat{ }−∞=1−0=1 (upper limit).

Therefore 0<1−b^{y-x}<1. The result of this sum has to be rounded to one of the values b⁰, b⁻¹ . . . b^{-m} for some value m. For x»y, b^{y-x} becomes infinitesimally small, and the middle term tends to 1. The smallest number that is of importance is the value for which \sqrt{b⁻¹}=1−b^{y-x}. That is, the value for y−x where the equation is so close to 1 that the rounded value will tend to 1 and not to b⁻¹.

This equation can be solved as follows:

\sqrt{b⁻¹}=1−b^{y-x}

1−\sqrt{b⁻¹}=b^{y-x}

log_{b}(1−\sqrt{b⁻¹})=y−x

For example, for K=4, this value is for y−x=−14.36. Hence, a look-up table having 15 entries mapped to values of y−x is required:

| | 1 − b^{y-x} | | Number to store |
|---|---|---|---|
| y − x | (rounded) | Sum S | in binary |
| 0 | Special representation of zero. | | |
| −1 | b⁻¹¹ | b^{x-B}b⁻¹¹ = | x − 11 |
| | | b^{x-B-11} | |
| −2 | b⁻⁷ | b^{x-B}b⁻⁷ = | x − 7 |
| | | b^{x-B-7} | |
| −3 | b⁻⁵ | b^{x-B}b⁻⁵ = | x − 5 |
| | | b^{x-B-5} | |
| −4 | b⁻⁴ | b^{x-B}b⁻⁴ = | x − 4 |
| | | b^{x-B-4} | |
| −5 | b⁻³ | b^{x-B-3} | x − 3 |
| −6 | b⁻³ | b^{x-B-3} | x − 3 |
| −7 | b⁻² | b^{x-B-2} | x − 2 |
| −8 | b⁻² | b^{x-B-2} | x − 2 |
| −9 | b⁻¹ | b^{x-B-1} | x − 1 |
| −10 | b⁻¹ | b^{x-B-1} | x − 1 |
| −11 | b⁻¹ | b^{x-B-1} | x − 1 |
| −12 | b⁻¹ | b^{x-B-1} | x − 1 |
| −13 | b⁻¹ | b^{x-B-1} | x − 1 |
| −14 | b⁻¹ | b^{x-B-1} | x − 1 |
| <−14 | b⁻⁰ | b^{x-B}b⁰ = b^{x-B} | x |

This means that subtracting two values Vₓ and V_{y} can be performed by subtracting the exponents y−x, picking a number from a small look-up table, and adding that to the exponent of the largest value. There are two special cases where the look-up table is not required, as evidenced by the table above. If x=y, the Sum S=0, and if x»y, the Sum S=Vₓ.

In the example above, the table requires 15 entries of 4 bits each. For the case where the number x is represented in binary by 7 bits, the subtraction involves a 7-bit subtraction, a look-up and a 7-bit addition.

For two negative numbers the above logic equally applies, but the answer is negative in that: Sum=−Vₓ+−V_{y}=−b^{x-B}+−b^{y-B}=−(b^{x-B}+−b^{y-B}). Therefore the sign bit of the resulting sum would be set to 1 (to represent a negative number). For a negative and a positive number, an addition is performed.

Multiplication

Two values can be multiplied by adding their exponents and subtracting the bias:

M=b^{x-B}*b^{y-B}=b^{x-B+y-B}=b^{x+y-2B}

Since the stored number x represents b^{x-B}, the result of the multiplication is stored in binary as x+y−B such that the bias is doubled.

Example:

Taking the first representation of the sine wave discussed above, a 11 bB attenuation may be applied to the signal as follows: −11 dB=10^{-11/20}=0.2818. The closest values in the number range are 0.2973 (for b⁻¹⁴) and 0.2726 (for b⁻¹⁵), so the closest value is 0.2726. Hence −11 dB is represented as b⁻¹⁵, sign bit 0, x=−15+127=112 (stored as 0x70 in binary).

The sine wave can be multiplied with b⁻¹⁵ as follows (where B=127):

multiply(0x00, 0x70)=0x00 (special case)

multiply(0x07b, 0x70)=123+112−127=108 (0x6C), this decodes as b⁻¹⁹=0.19277

multiply(0x07f, 0x70)=127+112−127=112 (0x70), this decodes as b⁻¹⁵=0.2726

multiply(0x07b, 0x70)=123+112−127=108 (0x6C), this decodes as b⁻¹⁹=0.19277

multiply(0x00, 0x70)=0x00 (special case)

The remaining three terms are the same as 0x6C, 0x70 and 0x6C, stored with a positive sign bit to represent negative numbers.

We can observe that 0.19277 is 11.288 dB lower than 0.7071, which is as close as we can get with the precision of this example number system.

Division

When dividing one value by another, the division is performed by subtracting their exponents and adding the bias:

D=b^{x-B}/b^{y-B}=b^{x-B-(y-B)}=b^{x-y}

Since the stored number x represents b^{x-B}, the result of the division is stored in binary as x−y+B such that the bias is cancelled out.

Square Root

A square root of a value is computed as:

\sqrt{b^{x-B}}=b^{(x-B)/2}=b^{x/2-B/2}

This is the result of a shift operation on x and an addition of B/2; the latter will guarantee that the bias term has been added again.

Overflow

The multiplication and addition operations may overflow. This is the case if the resulting exponent is larger than the maximum exponent that can be stored in binary. In this case we make the result infinite, using the aforementioned special representation. It means that we need to have one extra bit available in computing the output value so that we can detect an overflow. We observe that this requires less logic than in a traditional floating point number system since it cannot overflow twice. Traditional floating point number systems can overflow twice, once when rounding the mantissa, and then again on the exponent.

Underflow

The divide and subtraction operations may underflow. This is the case if the resulting exponent is smaller than the minimum exponent that we can store. In this case we make the result zero, using the aforementioned special representation. If the number representation accommodates for both a positive and a negative zero, then an underflow less than zero can result in −0.0, and an underflow larger than zero to +0.0. If only a single zero is supported, then both will underflow to 0.0. Note that we do not have to worry about subnormal numbers as found in the IEEE 754 floating point standard as we do not have a mantissa.

Not a Number

If not a number is supported, then this is will be the result of any of the following:
∞−x for any positive value x, including +∞
−∞+x for any positive value x
0/0
0*∞
Any operation involving NaN.

If both a positive and a negative NaN are supported, then the sign bit would be computed as normal.

Conversion to and from Floating Point Numbers

Conversion to a floating point number is performed as follows. We observe that:

b^{x}=2^{x/K}=2^{(x/K)+(x modK)/K}=2^{x/K}×2^{(x mod K)/K}

Hence, the number b^{x} can be represented as a floating point number with an exponent x/K and a mantissa 2^{(x mod K)/KK}; the latter is a number between 0 and 1 that can be looked up with a table of K values. If K is picked to be a power of 2, then the/and mod operations become shift and mask operations.

Conversion from a floating point number is performed as follows. The exponent of the floating point number has to be multiplied by K. The mantissa needs to be mapped on a number in the range [0 . . . K−1], and added to the previous value. This mapping requires K−1 comparisons.

Parameters

The value of n is typically a fixed value, with a typical value of n being 8 bits or a few more. The value of K is typically fixed as well, as it affects the size of the look-up tables for addition and subtraction. The value of K governs the total dynamic range and the ratio of subsequent numbers (b):

| K | B | Dynamic range | Range (dB) | Table sizes |
|---|---|---|---|---|
| 4 | 1.189207 | 2553802833 | 188 | 14 (add), 15 |
| | | | | (subtract) |
| 5 | 1.148698 | 33554432 | 150 | 20 (add), 20 |
| | | | | (subtract) |
| 6 | 0.122462 | 1868350 | 125 | 25 (add), 25 |
| | | | | (subtract) |
| 7 | 1.104090 | 237430 | 108 | 31 (add), 31 |
| | | | | (subtract) |
| 8 | 1.090508 | 50535 | 94 | 36 (add), 37 |
| | | | | (subtract) |

The dynamic range is calculated as the largest value divided by the smallest (non-zero) value. By choosing the value of K judiciously, we can have fine control over the dynamic range.

The value of B can be chosen by the user. B can be stored in a register to enable the correct calculation of the value when performing multiplication and division. It is not required elsewhere, as overflow and underflow can be calculated on the biased exponent. For n=7, if x+B<1, then the number underflows to 0, and if x+B>126, then the number overflows to 127 (1).

Embodiments of the invention provide a processor configured to perform at least some of the above described operations.

The processor architecture of a given processor will be designed to execute instructions instantiated from amongst a particular instruction set. The instruction set of a processor is the fundamental set of definitions of the kinds of machine code instruction that the processor is configured to execute. These will include a number of compute instructions, e.g. arithmetic instructions such as add, multiply, etc. Each instruction executed is an instance of one of the instruction types from the instruction set. Each instruction defined in the instruction set is a machine code instruction formed of an opcode and zero or more operand fields, wherein the opcode specifies the operation to be performed and the operand field(s) (if any) are used to specify one or more operands to be operated upon by the specified operation. An operand can be an immediate operand, i.e. the value to be operated upon is encoded directly into the instruction; or alternatively an operand can take the form of an indirect operand, i.e. an address where the value to be operated upon can be found. For instance an add instruction may take three pointers as operands: two specifying addresses from which to take values to be added, and another specifying a destination address to which to write the result.

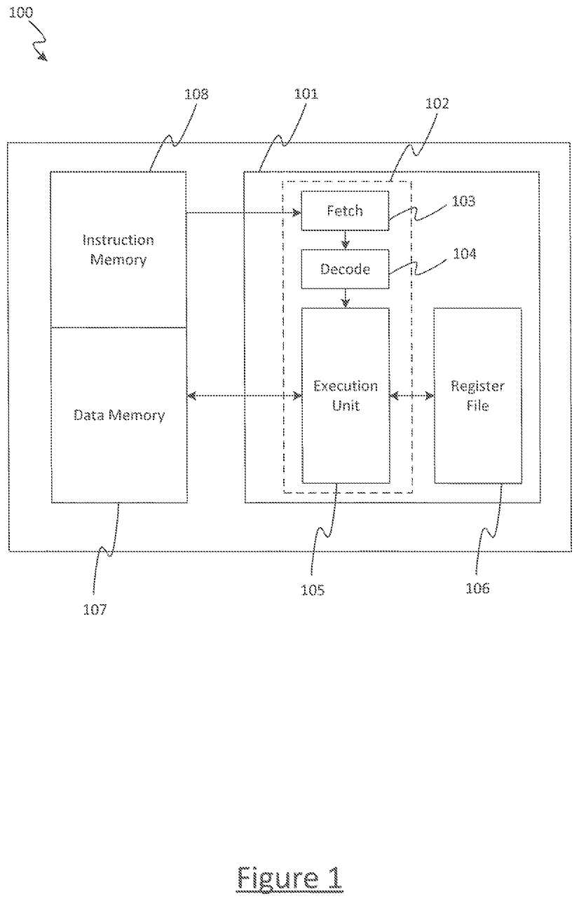

FIG. 1 illustrates an example computer system 100 comprising a processor 101. The processor 101 comprises a pipeline 102 comprising a series of pipeline stages. For example, the pipeline may comprise a fetch stage 103 that fetches an instruction, a decode stage 104 that decodes the instruction, and an execution unit 105. The execution unit 105 may comprise one or more stages, e.g. a register read stage that reads from a register file 106, a compute stage that performs computations (e.g. arithmetic operations), one or more memory access stages that may address memory, may read and write data to memory, etc., depending on the instruction. Note: the particular pipeline stages shown in FIG. 1 are illustrated here by way of example but this is not limiting, and the skilled will be aware of other possible pipeline variants.

The processor 101 may comprise a scheduler (not shown) coupled to the fetch stage 103. The execution unit 105 (e.g. the memory access stages of the execution unit 105) is coupled to a data memory 107. The input of the instruction fetch stage 103 is coupled to a separate instruction memory 108. The processor 101 comprises a register file 106, which comprises at least one set of registers, including operand registers for holding values to be operated on by instructions and values resulting from the operations performed by executed instructions. In embodiments, the register file 106 comprises a plurality of sets of registers, each arranged to represent the program state (context) of a different respective one of multiple program threads. Each set of context registers may comprise at least a respective program counter and a respective plurality of operand registers. Alternatively the processor 101 may simply employ a single-thread (non-multithreaded) architecture. Note also that most generally, a register file as referred to herein can refer to any group of registers up to the total set of addressable registers on the processor and does not limit to any particular physical module or sub-division in the register address space.

The data memory 107 is the memory where the data to be operated upon by computations and the results of the computations are ultimately stored (the operand registers being only a temporary holding place). The data memory may 107 be stored on the same physical unit as the processor 101. Alternatively, the data memory 107 may be storage on a separate unit, e.g. an external hard drive. In embodiments such as shown in FIG. 1, the instructions are stored in, and fetched from, an instruction memory 108 that is separate from the data memory 107. These may be separate memory devices or separate regions of the same memory device. Either way, since the instruction memory 108 and data memory 107 have non-overlapping address spaces, this means there is no risk that the instruction fetches performed by the fetch stage 103 will contend with the data access (load or store) being performed by the memory access stages. The data memory may comprise, but is not limited to, volatile storage (e.g., random access memory), non-volatile storage (e.g., read-only memory), flash memory, or any combination of such memories.

The compute instructions and the corresponding operations comprise one or more arithmetic instructions. Accordingly, the execution unit 105 comprises one or more arithmetic computation units for executing such instructions, such as a fixed point arithmetic unit (AU), logic unit (LU), arithmetic logic unit (ALU) or floating point unit (FLU). Arithmetic refers to mathematical operations on numbers: e.g. multiply, add, divide, subtract, etc. Compute can constitute a much wider set: e.g. if operand 0 is true, then operand 1 is stored in the destination, else operand 2 is stored in the destination. Another example may be that the result is the input operand with all the bits flipped around from left to right.

The processor may be a pipelined processor. In a pipelined processor, the execution unit is divided into a series of pipeline stages, each for performing a particular type of operation. The pipeline will typically include a fetch stage, decode stage, a register read stage, at least one compute stage, and one or more memory access stages. The instruction fetch stage fetches a first instruction from memory and issues it into the first stage of the pipeline. In the next processor cycle the decoded instruction passes down to the next stage in the pipeline, e.g. the register read stage. At the same time, the fetch stage fetches a second instruction from the instruction memory into the decode stage. In the next successive processor cycle after that, the first instruction is passed to the third pipeline stage, e.g. compute stage, while the second instruction is passed to the second pipeline stage, and a third instruction is issued into the first pipeline stage, and so forth. This helps keep the processor busy and thereby reduces latency, since otherwise the processor would need to wait for a whole instruction to execute before issuing the next into the execution unit.

The processor may be a multi-threaded processor. In a multi-threaded processor, the processor comprises a plurality of sets of context registers, each set of context registers representing a context (i.e. program state) of a respective one of multiple currently-executing program threads. The program state comprises a program counter for the respective thread, operands of the respective thread, and optionally respective status information such as whether the thread or context is currently active. The processor further comprises a scheduler which is configured to control the instruction fetch stage to temporally interleave instructions through the pipeline, e.g. in a round-robin fashion. Threads interleaved in such a manner are said to be executed concurrently. In the case where the execution unit is pipelined, then as the instruction of one thread advances through the pipeline from one pipeline stage to the next, the instruction of another thread advances down the pipeline one stage behind, and so forth.

This interleaved approach is beneficial as it provides more opportunity for hiding pipeline latency. Without the interleaving, the pipeline would need mechanisms to resolve dependencies between instructions in the pipeline (the second instruction may use the result of the first instruction, which may not be ready in time), which may create a pipeline bubble during which the second and further instructions are suspended until the first instruction has completed execution.

The register file comprises at least one bias register for holding (e.g. storing) the bias B. The bias number may be set by a user of the processor. The register file also comprises a plurality of operand registers for holding (e.g. storing) a respective number x. Each respective number may be stored with a sign bit (e.g. the first bit) which represents whether the number is positive or negative. As discussed above, together x and B represent a value V in the logarithmic number system, wherein x and B represent V by the mapping V=±b^{x-B}.

In embodiments employing multithreading, each set of context registers may comprise its own respective instance of the bias register and operand registers. When the execution unit executes on instruction of a given thread, it automatically uses the respective bias register and operand registers of the respective context. Alternatively, there may be a single instance of the bias register shared by each set of context registers.

The execution unit is configured to execute at least a logarithmic addition instruction. The logarithmic addition instruction is defined by a corresponding opcode (e.g. a log_add opcode), a first source operand field taking a first source operand specifying one of said operand registers as a first source register holding a first number x₁, a second source operand field taking a second source operand specifying one of said operand registers as a second source register holding a second number x₂, and a destination field taking a destination operand specifying one of said operand registers as a destination register. The result of the logarithmic addition instruction will be stored in the destination register.

In response to receiving the logarithmic addition opcode (e.g. after the instruction has been fetched and decoded by the fetch stage and decode stage respectively), the execution unit is configured to retrieve the first number x from the first source register and retrieve the second number y from the second source register. The execution unit is configured to subtract the first number from the second number. For example, the execution unit may be configured to determine which of the first and second numbers is the greatest, and subtract the smallest the number from the largest number.

If the determined difference (y−x) is greater than a predetermined threshold number, the execution unit is configured to determine (i.e. compute) the resulting number S_{add} to be the greatest of the first number and the second number. That is, the resulting number is max(x,y). The predetermined threshold number may be, for example, log_{b}(\sqrt{b}×−1), where b is configurable by a user of the processor, e.g. by setting the value of K, since b may be set as equal to 2^{1/K}. The value of K may be configured up to a limit governed by the lookup tables for addition and subtraction. In this case, the lookup tables have to be programmable.

If on the other hand, the determined difference (y-x) is less than or equal to the predetermined threshold number, the execution unit is configured to retrieve, from a logarithmic addition look-up table, a number x_{L} mapped to the determined difference, and add the number x_{L} to the first number x to determine a resulting number S_{add}. For example, if K=4, the number x_{L} may be retrieved from a look-up table like the one described above in the “Addition” sub-section.

The execution unit is further configured to store the resulting number Sana in the destination register.

In some embodiments, if the first number x is equal to the second number y, i.e. x=y, the execution unit may be configured to determine the resulting number as S_{add}=2x, and store that number in the destination register.

Each number (i.e. first number, second number, and the resulting number) is stored in binary in their corresponding associated registers. Additionally, the look-up table may be stored in the register file. In multithreaded embodiments there may be provided a single look-up table shared between all the contexts. Alternatively, each set of context registers may comprise its own respective instance of the look-up table,

The execution unit may be configured to execute a logarithmic subtraction instruction. The logarithmic subtraction instruction is defined by a corresponding opcode (e.g. a log_sub opcode), a first source operand field taking a first source operand specifying one of said operand registers as a first source register holding a first number xi, a second source operand field taking a second source operand specifying one of said operand registers as a second source register holding a second number x₂, and a destination field taking a destination operand specifying one of said operand registers as a destination register. The result of the logarithmic subtraction instruction will be stored in the destination register.

In response to receiving the logarithmic subtraction opcode (e.g. after the instruction has been fetched and decoded by the fetch stage and decode stage respectively), the execution unit is configured to retrieve the first number x from the first source register and retrieve the second number y from the second source register. The execution unit is configured to subtract the first number from the second number. For example, the execution unit may be configured to determine which of the first and second numbers is the greatest, and subtract the smallest the number from the largest number.

If the determined difference (y−x) is less than a predetermined threshold number, the execution unit is configured to determine the resulting number S_{add} to be the greatest of the first number and the second number. That is, the resulting number is max(x,y). The predetermined threshold number may be, for example, log_{b}(1−\sqrt{b⁻¹}), where b is configurable by a user of the processor, e.g. by setting the value of K, since b may be set as equal to 2^{1/K}.

If on the other hand, the determined difference (y−x) is less than or equal to the predetermined threshold number, the execution unit is configured to retrieve, from a logarithmic subtraction look-up table, a number x_{L} mapped to the determined difference, and add the number x_{L} to the first number x to determine a resulting number S_{sub}. For example, if K=4, the number x_{L} may be retrieved from a look-up table like the one described above in the “Subtraction” sub-section.

If the first number x is equal to the second number y, i.e. x=y, the execution unit may be configured to determine the resulting number as S_{sub}=0, and store that number in the destination register.

The execution unit is further configured to store the resulting number S_{sub} in the destination register. The logarithmic subtraction look-up table may be stored in the register file.

In embodiments of the invention, adding two values of opposite signs involve the subtraction logic, and subtracting two values of opposing signs involves the addition logic. This is in contrast to traditional 2's complement addition and subtraction where the addition and subtraction logic is the same.

When two numbers of equal sign are added, or two numbers of different signs are subtracted, then the result may be too large to be represented, in which case an infinite value of the appropriate sign is stored. This situation is referred to as overflow and is described below.

The execution unit may be configured to execute a logarithmic multiplication instruction. The logarithmic multiplication instruction is defined by a corresponding opcode (e.g. a log_mult opcode), a first source operand field taking a first source operand specifying one of said operand registers as a first source register holding a first number xi, a second source operand field taking a second source operand specifying one of said operand registers as a second source register holding a second number x2, and a destination field taking a destination operand specifying one of said operand registers as a destination register. The result of the logarithmic multiplication instruction will be stored in the destination register.

In response to receiving the logarithmic multiplication opcode (e.g. after the instruction has been fetched and decoded by the fetch stage and decode stage respectively), the execution unit is configured to retrieve the first number x from the first source register, retrieve the second number y from the second source register, and retrieve the bias number B from the bias register. The execution unit is configured to add the first and second numbers together and subtract the bias number to determine the resulting number Sₘᵤₗₜ (i.e. Sₘᵤₗₜ=x+y−B). The sum may be performed in any order, e.g. Sₘᵤₗₜ=y−B+x. The execution unit is further configured to store the resulting number in the destination register.

The execution unit may be configured to execute a logarithmic division instruction. The logarithmic division instruction is defined by a corresponding opcode (e.g. a log_div opcode), a first source operand field taking a first source operand specifying one of said operand registers as a first source register holding a first number xi, a second source operand field taking a second source operand specifying one of said operand registers as a second source register holding a second number x₂, and a destination field taking a destination operand specifying one of said operand registers as a destination register. The result of the logarithmic division instruction will be stored in the destination register.

In response to receiving the logarithmic division opcode (e.g. after the instruction has been fetched and decoded by the fetch stage and decode stage respectively), the execution unit is configured to retrieve the first number x from the first source register, retrieve the second number y from the second source register, and retrieve the bias number B from the bias register. The execution unit is configured to add the first and second numbers together and add the bias number to determine the resulting number S_{div} (i.e. S_{div}=x−y+B). The execution unit is further configured to store the resulting number in the destination register.

The execution unit may be configured to execute a logarithmic square root instruction. The logarithmic square root instruction is defined by a corresponding opcode (e.g. a log_sqrt opcode), a first source operand field taking a first source operand specifying one of said operand registers as a first source register holding a first number x₁, and a destination field taking a destination operand specifying one of said operand registers as a destination register. The result of the logarithmic square root instruction will be stored in the destination register.

In response to receiving the logarithmic square root opcode (e.g. after the instruction has been fetched and decoded by the fetch stage and decode stage respectively), the execution unit is configured to retrieve the first number x from the first source register and retrieve the bias number B from the bias register. The execution unit is configured to perform a right logical shift on the first number and add half of the bias number (i.e. B/2) to the right shifted first number to determine the resulting number S_{sqrt} (i.e. S_{sqrt}=(x/2)+(B/2)). The sum may be performed in any order, e.g. S_{sqrt}=(B/2)+(x/2). The execution unit is further configured to store the resulting number in the destination register.

A logical shift is a bitwise operation that shifts all the bits of an operand. Shifting right by n bits on a binary number has the effect of dividing it by 2ⁿ. Therefore shifting the first number by one bit will divide the number by 2.

The destination register specified in one, some or all of the instructions may have a predetermined bit width (e.g. 8 bits). The resulting number of the addition or multiplication instructions (S_{add} or Sₘᵤₗₜ) computed by the execution unit may be larger than the maximum number that can be held by the destination register (e.g. 255 for 8 bits, or 127 if a bit is used as a sign bit). In this case, the execution unit is configured to store, in the destination register, a sequence of bits representing infinity (e.g. 11111111). Infinite has a sign that is relevant is stored as plus or minus infinite as appropriate. Similarly, the resulting number of the subtraction or division instructions (S_{sub} or S_{div}) computed by the execution unit may be smaller than the minimum number that can be held by the destination register (e.g. 0 for 8 bits, or −127 if a bit is used as a sign bit). In this case, the execution unit is configured to store, in the destination register, a sequence of bits representing zero (e.g. 00000000).

When performing logarithmic addition or logarithmic subtraction computations, the execution unit makes use of a logarithmic addition look-up table or a logarithmic subtraction look-up table respectively. Each table comprises a plurality of entries, each representing a different difference between the first and second numbers, y−x. Each entry is mapped to a third number x_{L}. The third number is added to the first number to determine the resulting number (Sana or Ssub). The look-up tables are preconfigured and depend only on the value b. E.g. for b=2^{1/K}, where K=4, the look-up tables for addition and subtraction are given above.

For the logarithmic addition look-up table, each respective third number is equal to the value of 1+b^{(y-x)} rounded to the nearest value of bⁱ, wherein i is an integer (e.g. b⁰, b¹, etc.), whereas for the logarithmic subtraction look-up table, each respective third number is equal to the value of 1−b^{y-x}.

It will be appreciated that the above embodiments have been described by way of example only. Other variants or applications of the presently disclosed concepts may become apparent to a person skilled in the art once given the disclosure herein. The scope of the present disclosure is not limited by the above-described embodiments but only by the accompanying claims.

1. A processor comprising:
a register file comprising a plurality of registers, including a bias register for holding a bias and a plurality of operand registers each for holding a respective number which together with the bias represents a respective value in a logarithmic number system; and
an execution unit configured to execute machine code instructions, each instruction being an instance of a predefined set of instruction types in an instruction set of the processor, wherein the instruction set includes a logarithmic addition instruction defined by a corresponding opcode, a first source operand field taking a first source operand specifying a first source holding a first number, a second source operand field taking a second source operand specifying a second source holding a second number, and a destination field taking a destination operand specifying one of said operand registers as a destination register;
wherein the execution unit is configured to, in response to the logarithmic addition opcode:
retrieve the first number from the first source specified in the logarithmic addition instruction;
retrieve the second number from the second source specified in the logarithmic addition instruction;
subtract the first number from the second number to determine a difference; and
if the determined difference is less than or equal to a predetermined threshold number, retrieve, from a logarithmic addition look-up table, a third number mapped to the determined difference, and add the third number to the first number to determine a resulting number; and
if the determined difference is greater than the predetermined threshold number, determine the resulting number to be the greatest of the first number and the second number; and
store the resulting number in the destination register specified in the logarithmic addition instruction.

2. A processor according to claim 1, wherein the logarithmic addition look-up table is stored in the register file.

3. A processor according to claim 1, wherein the instruction set includes a logarithmic subtraction instruction defined by a corresponding opcode, a first source operand field taking a first source operand specifying a first source holding a first number, a second source operand field taking a second source operand specifying a second source holding a second number, and a destination field taking a destination operand specifying one of said operand registers as a destination register;
wherein the execution unit is configured to, in response to the logarithmic subtraction opcode:
retrieve the first number from the first source specified in the logarithmic subtraction instruction;
retrieve the second number from the second source specified in the logarithmic subtraction instruction;
subtract the first number from the second number to determine a difference; and
if the determined difference is less than or equal to a predetermined threshold number, retrieve, from a logarithmic subtraction look-up table, a third number mapped to the determined difference, and add the third number to the first number to determine a resulting number; and
if the determined difference is less than the predetermined threshold number, determine the resulting number to be the greatest of the first number and the second number; and
store the resulting number in the destination register specified in the logarithmic subtraction instruction; and
if the first number is equal to the second number, determine the resulting number to be zero; and
store the resulting number in the destination register specified in the logarithmic subtraction instruction.

4. A processor according to claim 3, wherein the logarithmic subtraction look-up table is stored in the register file.

5. A processor according to claim 1, wherein the instruction set includes a logarithmic multiplication instruction defined by a corresponding opcode, a first source operand field taking a first source operand specifying a first source holding a first number, a second source operand field taking a second source operand specifying a second source holding a second number, and a destination field taking a destination operand specifying one of said operand registers as a destination register;
wherein the execution unit is configured to, in response to the logarithmic multiplication opcode:
retrieve the first number from the first source specified in the logarithmic multiplication instruction;
retrieve the second number from the second source specified in the logarithmic multiplication instruction;
retrieve the bias from the bias register;
determine the resulting number by adding the first and second numbers and subtracting the bias; and
store the resulting number in the destination register specified in the logarithmic multiplication instruction.

6. A processor according to claim 1, wherein the instruction set includes a logarithmic division instruction defined by a corresponding opcode, a first source operand field taking a first source operand specifying a first source holding a first number, a second source operand field taking a second source operand specifying a second source holding a second number, and a destination field taking a destination operand specifying one of said operand registers as a destination register;
wherein the execution unit is configured to, in response to the logarithmic division opcode:
retrieve the first number from the first source specified in the logarithmic division instruction;
retrieve the second number from the second source specified in the logarithmic division instruction;
retrieve the bias from the bias register;
determine the resulting number by subtracting the first and second numbers and adding the bias; and
store the resulting number in the destination register specified in the logarithmic division instruction.

7. A processor according to claim 1, wherein the destination register specified in the logarithmic addition instruction or the logarithmic multiplication instruction each have a predetermined bit width, and wherein if the resulting number is larger than a maximum number that can be held by the predetermined bit width, the execution unit is configured to store, in the destination register specified in the logarithmic addition instruction or the logarithmic multiplication instruction, a sequence of bits representing infinity.

8. A processor according to claim 3, wherein the destination register specified in the logarithmic subtraction instruction or the logarithmic division instruction each have a predetermined bit width, and wherein if the resulting number is less than a minimum number that can be held by the predetermined bit width, the execution unit is configured to store, in the destination register specified in the logarithmic subtraction instruction or the logarithmic division instruction, a sequence of bits representing zero.

9. A processor according to claim 1, wherein the instruction set includes a logarithmic square root instruction defined by a corresponding opcode, a first source operand field taking a first source operand specifying a first source holding a first number, and a destination field taking a destination operand specifying one of said operand registers as a destination register;
wherein the execution unit is configured to, in response to the logarithmic square root opcode:
retrieve the first number stored in the first source specified in the logarithmic square root instruction;
retrieve the bias from the bias register;
determine the resulting number by performing a right logical shift on the first number and adding half of the bias to the shifted first number; and
store the resulting number in the destination register specified in the logarithmic square root instruction.

10. A processor according to claim 1, wherein the first source and the second source are each at least one of: a respective one of said operand registers, and a respective data location in memory.

11. A processor according to claim 1, wherein each number held in the set of operand registers comprises a sign bit representing a positive or negative sign of the number.

12. A processor according to claim 1, wherein the bias is configurable by a user.

13. A processor according to claim 1, wherein the logarithmic addition look-up table comprises a plurality of entries each representing a different difference, y-x, between the second number and the first number, and wherein each entry is mapped to a respective third number, wherein each respective third number is equal to the value of 1+b^{y-x} rounded to the nearest value of bⁱ, wherein i is an integer, and wherein b is a base number for representing the value in the logarithmic number system using a number and the bias.

14. A processor according to claim 4, wherein the logarithmic subtraction look-up table comprises a plurality of entries each representing a different difference, y−x, between the second number and the first number, and wherein each entry is mapped to a respective third number, wherein each respective third number is equal to the value of 1−b^{y-x} rounded to the nearest value of bⁱ, wherein i is an integer, and wherein b is the base number for representing the value in the logarithmic number system using a number and the bias.

15. A processor according to claim 13, wherein b=2^{1/K}, and wherein K is configurable by the user.

16. A computer-readable storage medium comprising instructions which, when executed by a computer system comprising a processor according to claim 1, cause the computer system to:
convert one or more respective values V stored in data memory into a respective number x, wherein the conversion is based on the logarithmic mapping V=b^{x-B}, where B is the bias and b is a predetermined base number;
supply the one or more respective numbers to the processor to be held in a respective one of the plurality of operand registers of the processor;
retrieve the resulting number held in the destination register from the processor; and
convert the resulting number into a resulting value to be stored in data memory based on the logarithmic mapping.

17. A computer system comprising:
a processor; and
a computer-readable storage medium according to claim 16.

18. A method of operating a processor, wherein the processor comprises: a register file comprising a plurality of registers, including a bias register for holding a bias and a plurality of operand registers each for holding a respective number which together with the bias represents a respective value in a logarithmic number system; and an execution unit configured to execute machine code instructions, each instruction being an instance of a predefined set of instruction types in an instruction set of the processor, wherein the instruction set includes a logarithmic addition instruction defined by a corresponding opcode, a first source operand field taking a first source operand specifying a first source holding a first number, a second source operand field taking a second source operand specifying a second source holding a second number, and a destination field taking a destination operand specifying one of said operand registers as a destination register, and wherein the method comprises, in response to the logarithmic addition opcode, the exaction unit performing operations of:
retrieving the first number from the first source specified in the logarithmic addition instruction;
retrieving the second number from the second source specified in the logarithmic addition instruction;
subtracting the first number from the second number to determine a difference; and
if the determined difference is less than or equal to a predetermined threshold number, retrieving, from a logarithmic addition look-up table, a third number mapped to the determined difference, and adding the third number to the first number to determine a resulting number; and
if the determined difference is greater than the predetermined threshold number, determining the resulting number to be the greatest of the first number and the second number; and
storing the resulting number in the destination register specified in the logarithmic addition instruction.
